(19) United States
(12) Patent Application Publication
(10) Pub. No.: US 2022/0293385 A1
(43) Pub. Date: Sep. 15, 2022

(54) SURFACE MOUNT FUSE

(71) Applicant: CONQUER ELECTRONICS CO.,LTD., New Taipei City (TW)

(72) Inventors: Hung-Chih CHIU, New Taipei City (TW); Po-Shuo CHIU, New Taipei City (TW)

(21) Appl. No.: 17/335,581

(22) Filed: Jun. 1, 2021

(30) Foreign Application Priority Data
Mar. 11, 2021 (TW) 110108778

(51) Int. Cl. H01H 85/041; H01H 85/165

(52) U.S. Cl. CPC H01H 85/0411; H01H 85/165; H01H 2085/0414; H01H 85/06

(57) ABSTRACT

A surface mount fuse has a housing, a conductive fuse and a cover. The housing has an opening and a non-airtight interior space. The conductive fuse is disposed inside the non-airtight interior space. The cover covers the opening. Because the interior space of the housing is a non-airtight interior space and the conductive fuse is disposed inside the non-airtight interior space. The conductive fuse is not encapsulated by the materials with low thermal conductivity to avoid heat accumulation, so the conductive fuse may avoid the aging. Further, the internal atmospheric pressure and the external atmospheric pressure of the housing may be balanced. Therefore, the conductive fuse is not suffered from the pressure caused by the pressure difference between internal and external of the housing so that the reliability of the surface mount fuse is enhanced.

### CROSS-REFERENCE TO RELATED APPLICATIONS

This application is based upon and claims priority under 35 U.S.C. 119 from Taiwan Patent Application No. 110108778 filed on Mar. 11, 2021, which is hereby specifically incorporated herein by this reference thereto.

### BACKGROUND OF THE INVENTION

### 1. Field of the Invention

The present disclosure relates to a surface mount fuse, particularly, to a surface mount fuse mounted with a surface mounting technology.

### 2. Description of the Prior Arts

The traditional fuse includes a fusible element. When an abnormal condition (e.g., overcurrent) occurs to a circuit, having the fuse connected in series for protection, the fusible element is fused due to overheating. Thus, the protected circuit is opened thereby achieving the function of circuit protection. When the fusible element is fused, the electric field intensity at both ends of the break point is extremely strong that makes the air, which should be the insulating medium, easily being broken down and generate an arc, so that the circuit cannot be opened immediately and resulted in the fuse malfunctioned. Therefore, in the prior art of the fuse, the fusible element is coated with an arc-eliminating material to absorb the arc generated by the fusible element and achieve the effect of arc-eliminating.

The arc-eliminating material has poor thermal conductivity, which makes it difficult for the fusible element to disperse heat to the surface of the fuse, and heat is easy to accumulate on the fusible element. Meanwhile, since the fusible element is sealed into the fuse by the arc-eliminating material, the pressure is generated on the fusible element due to the pressure difference when the environmental pressure of the fuse changes. These two issues make the fusible element easy to be aging early, so that the fusible element may be fused before reaching the rated current due to high temperature and resulted in the decreasing of the reliability of the fuse. It is necessary to further improve it.

To overcome the shortcomings, the present invention provides a surface mount fuse to mitigate or to obviate the aforementioned problems.

### SUMMARY OF THE INVENTION

In view of the shortcomings of the above fuse, the main objective of the present disclosure is to provide a surface mount fuse to improve the reliability of the surface mount fuse.

The main technical features used to achieve the objective of the invention is that the surface mount fuse includes:

a housing, comprising an opening and a non-airtight inner space;

a fusible element, comprising a fusible body, two intermediary portions and two conductive portions, wherein each of the intermediary portions is connected between a corresponding end of the fusible body and the corresponding conductive portion, the fusible body and the two intermediary portions are disposed within the non-airtight inner space of the housing, and each of the conductive portions is disposed on the opening of the housing and extends out of the housing; and

a cover, disposed on the opening of the housing.

According to the above description, since the inner space of the housing is a non-airtight inner space, the fusible body is directly disposed within the non-airtight inner space and is no longer covered by the material with poor thermal conductivity, which avoids heat accumulation and accelerated aging. In addition, the internal pressure of the housing is balanced with the external pressure, so that the fusible body disposed within the non-airtight inner space of the housing no longer bears the pressure caused by the pressure difference between inside and outside of the housing, and therefore the reliability of the surface mount fuse can be improved.

Other objectives, advantages and novel features of the invention will become more apparent from the following detailed description when taken in conjunction with the accompanying drawings.

### BRIEF DESCRIPTION OF THE DRAWINGS

FIG. 1A is a perspective view of a first embodiment of a surface mount fuse in accordance with the present invention;

FIG. 1B is a side view of the surface mount fuse in FIG. 1A;

FIG. 2 is a perspective view of a second embodiment of a surface mount fuse in accordance with the present invention;

FIG. 3 is an exploded perspective view of the surface mount fuse in FIG. 2;

FIG. 4A is a cross-sectional side view of the surface mount fuse in FIG. 2 along line A-A;

FIG. 4B is a cross-sectional end view of the surface mount fuse in FIG. 2 along line B-B;

FIG. 5 is a cross-sectional end view of a third embodiment of a surface mount fuse in accordance with the present invention;

FIG. 6 is a cross-sectional end view of a fourth embodiment of a surface mount fuse in accordance with the present invention;

FIG. 7A is a cross-sectional end view of a fifth embodiment of a surface mount fuse in accordance with the present invention;

FIG. 7B is a top view of the surface mount fuse in FIG. 7A;

FIG. 8 is a perspective view of a second embodiment of a fusible element of the surface mount fuse in accordance with the present invention;

FIG. 9 is a perspective view of a sixth embodiment of a surface mount fuse in accordance with the present invention;

FIG. 10A is an operational top view of a third embodiment of a fusible element before bending in accordance with the present invention; and

FIG. 10B is an operational perspective view of the third embodiment of the fusible element after bending.

### DETAILED DESCRIPTION OF THE EMBODIMENTS

The present disclosure provides an improved surface mount fuse and elaborates the technical content of the present disclosure with a plurality of embodiments and schematic diagrams.

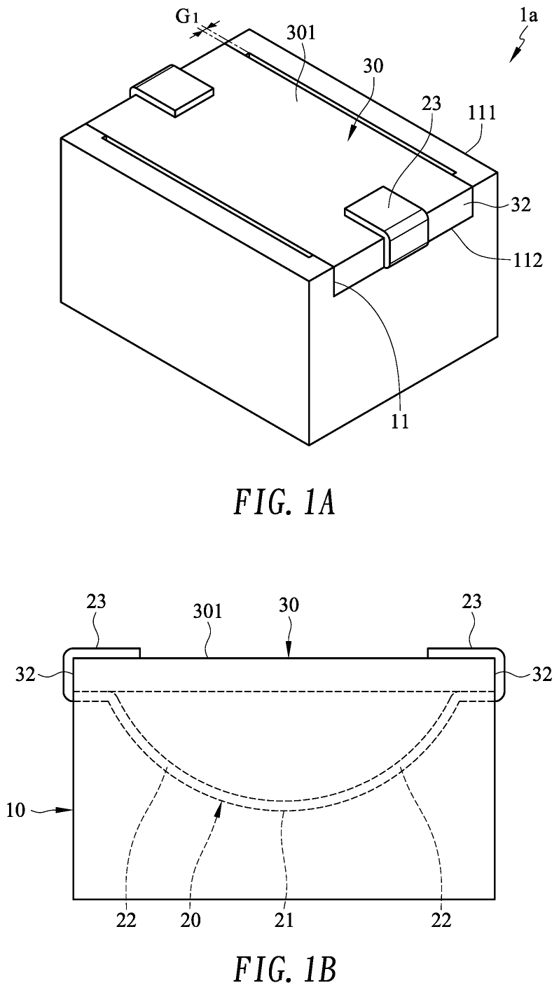

Referring to FIG. 1A and FIG. 1B, a surface mount fuse 1a of a first embodiment in accordance with the present invention includes a housing 10, a fusible element 20 and a cover 30.

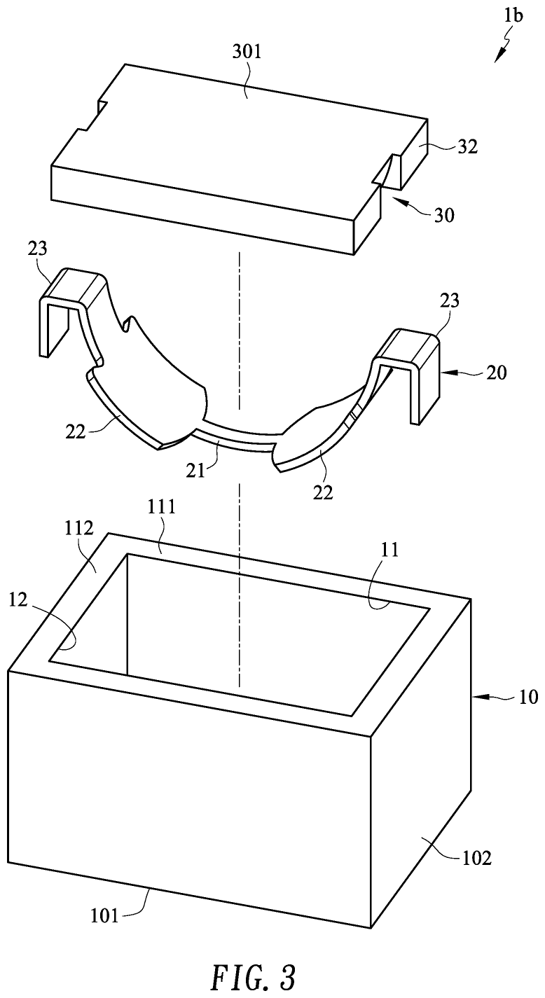

As shown in FIG. 3, the housing 10 includes an opening 11 and an inner space 12. In the present embodiment, the housing 10 is cuboid and includes a rectangular main wall 101 and sidewalls 102 extending vertically from the four sides of the main wall 101. The sidewalls 102 are connected to each other to form the inner space 12 and the opening 11. The opening 11 of the box-shaped housing 10 is rectangular and includes two opposing first sides 111 and two opposing second sides 112. In one embodiment as in FIG. 1A, the height of the two opposing first sides 111 is higher than the height of the two opposing second sides 112. In one embodiment, the first sides 111 are the longer sides and the second sides 112 are the shorter side. The material of the housing 10 is a ceramic material, but is not limited thereto.

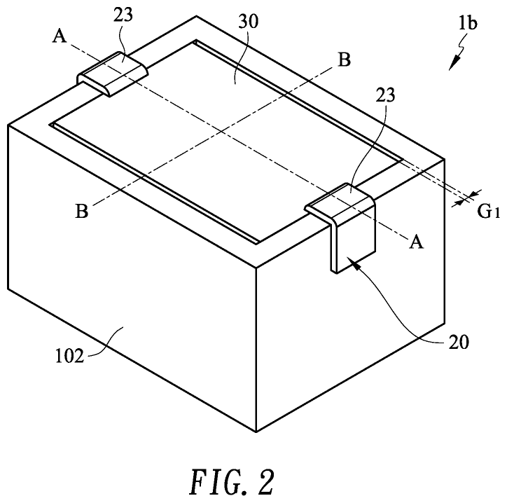

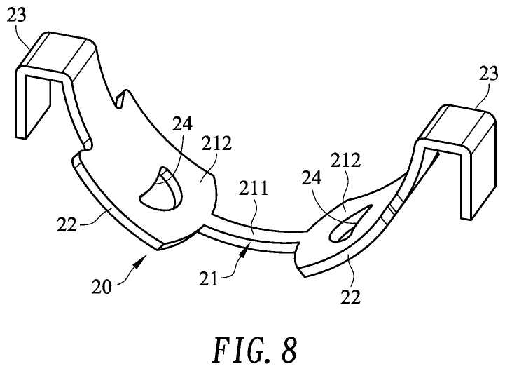

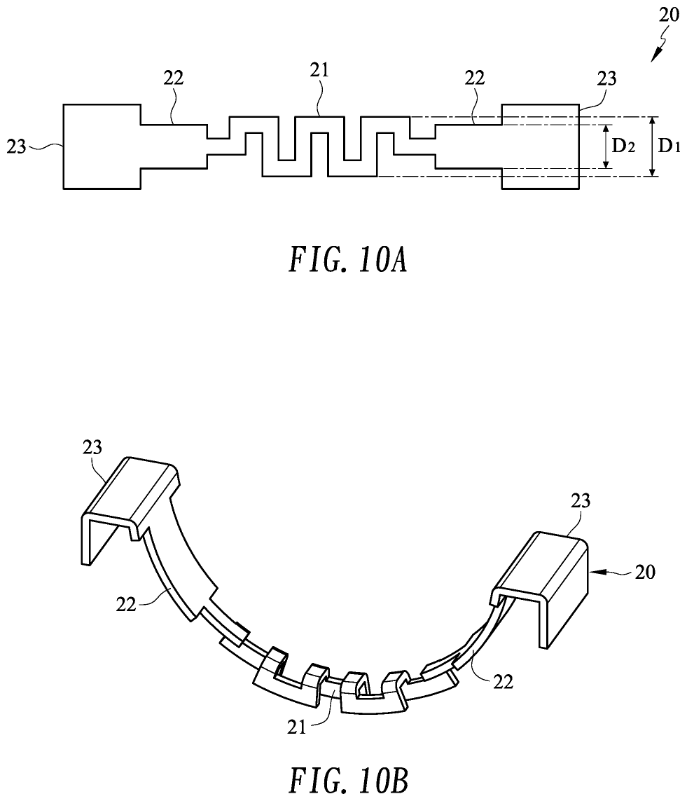

The fusible element 20 is mounted on the opening 11 of the housing and includes a fusible body 21, two intermediary portions 22 and two conductive portions 23. In the present embodiment as shown in FIG. 1B and FIG. 3, each of the intermediary portions 22 is connected between a corresponding end of the fusible body 21 and the corresponding conductive portion 23 in one-piece. The fusible body 21 and the two intermediary portions 22 are adapted to accommodate into the inner space 12 of the housing 10 and curved downward toward the main wall 101 of the housing 10. The two conductive portions 23 of the fusible element 20 are disposed on the two opposing second sides 112 of the housing 10, respectively. In addition, as shown in FIG. 8, the fusible body 21 further includes a first segment 211 and two second segments 212 respectively facing toward the intermediary portions 22. The first segment 211 has a linear shape, and the width of the first segment 211 is less than the width of each of the second segments 212. A gap 24 is formed in each of the second segments 212, so that the distance between the both ends of the fusible body 21 can be lengthen by the gaps 24 after the fusible body 21 being fused, and thus reduce the possibility to generate the electric arc. In another embodiment as shown in FIG. 10A, the fusible body 21 is bent in a non-linear plane path so that the fusible body 21 extends the total length without increasing the distance between the intermediary portions 22 to protect circuits with lower rated current (e.g., 10 A to 0.5 A). In addition, the width D₁ of the fusible body 21 is greater than the width D₂ of each intermediary portion 22. Further referring to FIG. 10B, before the fusible element 20 is placed into the inner space 12 of the housing 10 as shown in FIG. 2, the fusible body 21 and the two intermediary portions 22 of the fusible element 20 are bent downward toward the main wall 101 to form an arc shape, that is, the fusible body 21 and the two intermediary portions 22 are bent away from the opening 11, and the both sides of the fusible body 21 are also bent away from the opening 11 to reduce the width of the fusible body 21. Thus, the fusible element 20 can be more easily placed into the inner space 12 of the housing 10.

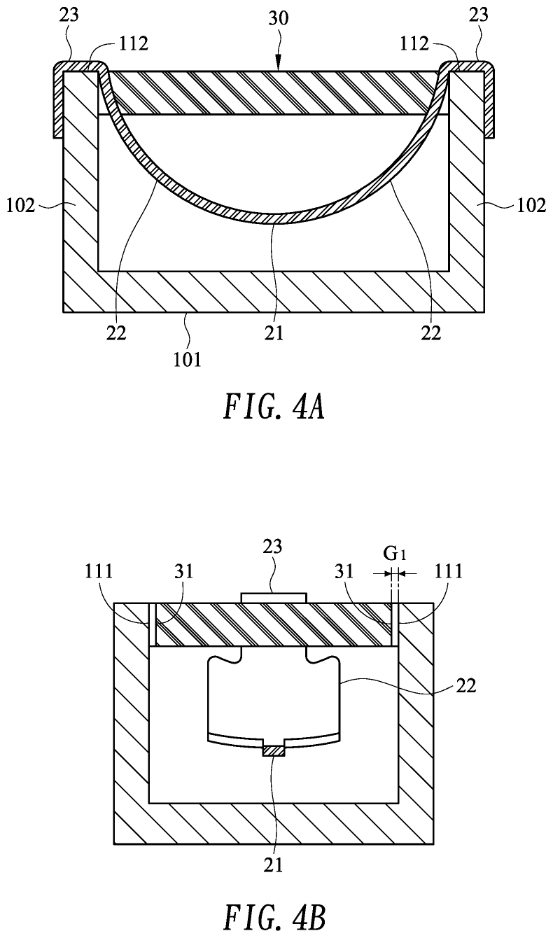

The cover 30 is fitted into the opening 11 of the housing to cover and accommodate the fusible body 21 of the fusible element 20 into the inner space 12 of the housing 10. In the present embodiment, as shown in FIGS. 1A, 1B and 4B, the cover 30 is cuboid, which means the cover 30 includes two opposing third sides 31 and two opposing fourth sides 32. The two fourth sides 32 are disposed on two second sides 112 of the opening 11, and the external surface 301 of the cover 30 is flush with two first sides 111 of the opening 11, so that the two conductive portions 23 of the fusible element 20 are respectively disposed on the two opposing second sides 112 of the opening 11. The conductive portions 23 are respectively bent toward the corresponding forth side 32 and the external surface 301 of the cover 30 and attached to it. A gap G₁ is formed between the two opposing third sides 31 of the cover 30 and the two opposing first sides 111 of the opening 11, and thus the inner space 12 is connected to the outer space of housing 10 to form a non-airtight inner space 12. In one embodiment, the cover 30 is made by a ceramic material or a plastic material.

Referring to FIGS. 2, 3, 4A and 4B, a second embodiment of the surface mount fuse 1b in accordance with the present invention is similar to the first embodiment shown in FIG. 1A, except that the two opposing first sides 111 and the two opposing second sides 112 of the opening 11 of the housing 10 are of the same height. Therefore, the two conductive portions 23 of the fusible element 20 are respectively disposed on the two second sides 112 of the opening 11 of the housing 10. The conductive portions 23 are extended to the outer surface of the sidewall 102 corresponding to the housing 10 and attached to it.

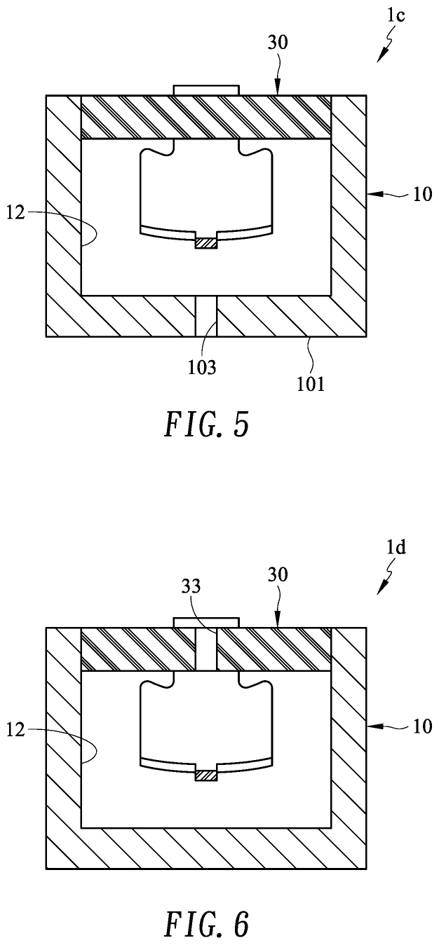

Referring to FIG. 5, a third embodiment of the surface mount fuse 1c in accordance with the present invention is similar to the second embodiment shown in FIG. 4, except that the cover 30 is airtightly fitted into the opening 11 of the housing 10. The housing has a hole 103, so that the inner space 12 is still a non-airtight inner space. In the present embodiment, the hole 103 may be formed on the rectangular main wall 101 of the housing 10, but is not limited thereto. The hole 103 is be formed on any sidewalls 102 of the housing 10.

Referring to FIG. 6, a fourth embodiment of the surface mount fuse 1d in accordance with the present invention is similar to the third embodiment shown in FIG. 5. In the present embodiment, the cover 30 is also airtightly fitted into the opening 11 of the housing 10. The difference between the present embodiment and that of the third embodiment shown in FIG. 5 is that the cover 30 further has a hole 33 communicating with the inner space 12, so that the inner space 12 is also a non-airtight inner space.

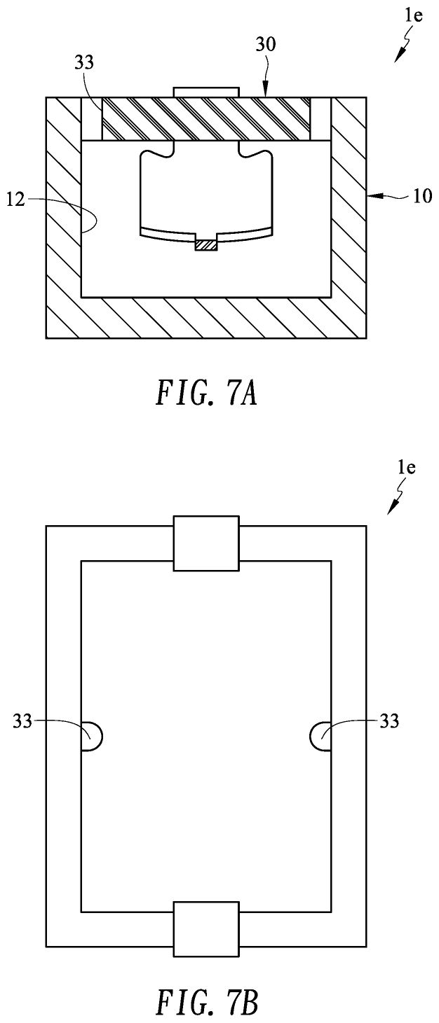

Referring to FIGS. 7A and 7B, a fifth embodiment of the surface mount fuse 1e in accordance with the present invention is similar to the second embodiment shown in FIG. 2, except that the surface mount fuse 1e includes two holes 33, respectively formed on the two opposing third sides 31 and communicating with the inner space 12, so that the inner space 12 also communicates with the external of the housing 10.

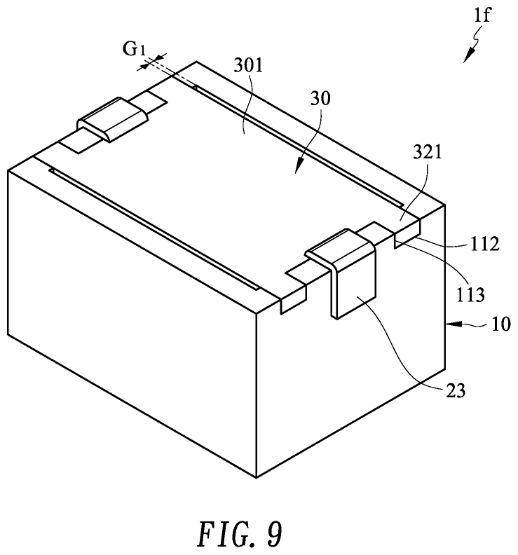

Referring to FIG. 9, a sixth embodiment of the surface mount fuse 1f in accordance with the present invention is similar to the second embodiment shown in FIG. 2. In the present embodiment, the housing 10 has two buttonholes 113 respectively formed on the two opposing second sides 112 of the opening 11. The cover 30 has two buttons 321 extended from the corresponding two opposing fourth sides 32 in order to fit into the buttonholes 113 of the opening 11. In one embodiment, the cover 30 is made by a plastic material.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

1. A surface mount fuse comprising:
a housing comprising an opening and a non-airtight inner space;
a fusible element comprising a fusible body, two intermediary portions and two conductive portions, wherein the fusible body, the two intermediary portions and the two conductive portions are formed integrally, each of the intermediary portions is connected between a corresponding end of the fusible body and the corresponding conductive portion, the fusible body and the two intermediary portions are disposed within the non-airtight inner space of the housing, and each of the conductive portions is disposed on the opening of the housing and extends out of the housing; and
a cover disposed on the opening of the housing.

2. The surface mount fuse according to claim 1, wherein the two intermediary portions and the fusible body are bent away from the opening to form an arc shape.

3. The surface mount fuse according to claim 2, wherein a gap is formed between at least one side of the cover and at least one corresponding side of the opening.

4. The surface mount fuse according to claim 2, wherein:
the cover is airtightly fitted into the opening of the housing; and
at least one hole is formed on the cover.

5. The surface mount fuse according to claim 4, wherein the at least one hole is formed on at least one side of the cover.

6. The surface mount fuse according to claim 2, wherein:
the cover is airtightly fitted into the opening of the housing; and
at least one hole is formed on the housing.

7. The surface mount fuse according to claim 3, wherein the opening of the housing is rectangular and the cover is cuboid, the opening comprises two first sides and two second sides, and the cover comprises two third sides and two fourth sides, wherein
the cover is configured to dispose in the opening; and
the two conductive portions of the fusible element are respectively disposed on the two second sides of the opening, and extended toward an outer surface of the housing and attached to it.

8. The surface mount fuse according to claim 6, wherein the opening of the housing is rectangular and the cover is cuboid, the opening comprises two first sides and two second sides, and the cover comprises two third sides and two fourth sides, wherein
the cover is configured to dispose in the opening; and
the two conductive portions of the fusible element are respectively disposed on the two second sides of the opening, and extended toward an outer surface of the housing and attached to it.

9. The surface mount fuse according to claim 3, wherein the opening of the housing is rectangular and the cover is cuboid, the opening comprises two first sides and two second sides, and the cover comprises two third sides and two fourth sides, wherein
the height of the two first sides of the opening is higher than the height of the two second sides;
the two fourth sides of the cover are disposed on the two second sides of the opening, and an external surface of the cover is flush with the two first sides of the opening; and
the two conductive portions of the fusible element are respectively disposed on the two second sides of the opening, extended toward the corresponding fourth side of the cover and attached to the external surface of the cover.

10. The surface mount fuse according to claim 6, wherein the opening of the housing is rectangular and the cover is cuboid, the opening comprises two first sides and two second sides, and the cover comprises two third sides and two fourth sides, wherein
the height of the two first sides of the opening is higher than the height of the two second sides;
the two fourth sides of the cover are disposed on the two second sides of the opening, and an external surface of the cover is flush with the two first sides of the opening; and
the two conductive portions of the fusible element are respectively disposed on the two second sides of the opening, extended toward the corresponding fourth side of the cover and attached to the external surface of the cover.

11. The surface mount fuse according to claim 3, wherein the opening of the housing is rectangular and the cover is cuboid, the opening comprises two first sides and two second sides, and the cover comprises two third sides and two fourth sides, wherein
at least one buttonhole is formed on each of the two second sides of the opening;
a button is disposed and horizontally extended from each of the two fourth sides, respectively corresponding to the buttonholes on the first sides, and configured to assemble the corresponding buttonhole; and
the two conductive portions of the fusible element are respectively disposed on the two second sides of the opening, extended toward an outer surface of the housing and attached to it.

12. The surface mount fuse according to claim 6, wherein the opening of the housing is rectangular and the cover is cuboid, the opening comprises two first sides and two second sides, and the cover comprises two third sides and two fourth sides, wherein
at least one buttonhole is formed on each of the two second sides of the opening;
a button is disposed and horizontally extended from each of the two fourth sides, respectively corresponding to the buttonholes on the first sides, and configured to assemble the corresponding buttonhole; and
the two conductive portions of the fusible element are respectively disposed on the two second sides of the opening, extended toward an outer surface of the housing and attached to it.

13. The surface mount fuse according to claim 1, wherein the fusible body of the fusible element further comprises:
a first segment; and
two second segments, extended from two end of the first segment, and respectively connected to the corresponding intermediary portion, wherein a hole is formed on each of the two second segments.

14. The surface mount fuse according to claim 6, wherein the fusible body of the fusible element further comprises:
a first segment; and
two second segments, extended from two end of the first segment, and respectively connected to the corresponding intermediary portion, wherein a hole is formed on each of the two second segments.

15. The surface mount fuse according to claim 13, wherein
the first segment of the fusible body has a linear shape; and
the width of the two intermediary portions is greater than the width of the first segment of the fusible body.

16. The surface mount fuse according to claim 14, wherein:
the first segment of the fusible body has a linear shape; and
the width of the two intermediary portions is greater than the width of the first segment of the fusible body.

17. The surface mount fuse according to claim 1, wherein
the fusible body of the fusible element is bent in a non-linear plane path.

18. The surface mount fuse according to claim 6, wherein
the fusible body of the fusible element is bent in a non-linear plane path.
